(19) United States
(12) Patent Application Publication
(10) Pub. No.: US 2018/0309095 A1
(43) Pub. Date: Oct. 25, 2018

(54) HOUSING MATERIAL FOR POUCH-TYPE BATTERY AND POUCH-TYPE BATTERY INCLUDING SAME

(71) Applicant: Unifrax I LLC, Tonawanda, NY (US)

(72) Inventors: James Olchawski, Corfu, NY (US); Melissa WIDENER, North Tonawanda, NY (US)

(21) Appl. No.: 15/957,150

(22) Filed: Apr. 19, 2018

Related U.S. Application Data
(60) Provisional application No. 62/487,441, filed on Apr. 19, 2017.

(51) Int. Cl. H01M 2/02; H01M 10/0525; H01M 10/0587

(52) U.S. Cl. CPC H01M 2/029; H01M 2/0277; H01M 2/0275; H01M 10/0587; H01M 10/0525

(57) ABSTRACT

A pouch-type electrochemical battery comprising at least one electrochemical battery cell encapsulated within a housing material comprising an inorganic platelet composition.

This application claims the benefit of the filing date under 35 U.S.C. § 119(e) from U.S. Provisional Application for Patent Ser. No. 62/487,441, filed on Apr. 19, 2017.

The present disclosure relates to a thermal insulation and/or electrical insulation and fire protection housing material for pouch-type electrochemical batteries, and pouch-type electrochemical batteries including the thermal insulation and fire protection material. For simplicity, the terms “thermal insulation” and “electrical insulation” as used herein are intended to include within their respective meanings both thermal and electrical insulating functionality, unless context dictates otherwise.

Lithium ion batteries, such as lithium ion polymer batteries, ore widely used to provide power to electric or hybrid vehicles (such as automobiles, buses, trucks, motorcycles, motorized bicycles, etc.), aircraft, marine craft, power tools, energy storage systems (such as uninterruptable power supplies, stationary storage systems, and/or for electric grid back-up applications), and portable electronic devices such as lap top, notebook and tablet computers, cellular telephones, smart telephones, digital cameras, digital camcorders, handheld gaming devices, MP3 players, PDAs, iPods, flashlights and like electronic devices.

Pouch-type lithium ion polymer batteries include an outer housing material which completely encapsulates the pouch-type battery. Enclosed within the outer housing material are a cathode (i.e., positive electrode), an anode (i.e., negative electrode) and a micro-porous electrolyte (which also acts as a separator). In a typical pouch-type lithium ion polymer battery, the cathode, anode and electrolyte are provided in the form of a prismatic (i.e., flattened) roll of thin sheets. The electrolyte separates the anode and cathode while permitting lithium ions to pass through it.

In a typical lithium ion cell the cathode may be made from lithium cobalt oxide (LiCoO₂), lithium iron phosphate (LiFePO₄), lithium titanium oxide (Li₂TiO₃), nickel manganese cobalt, nickel cobalt aluminum, or lithium manganese oxide (LiMn₂O₄). The anode may be made of carbon (such as graphite), or lithium titanium oxide (Li₄Ti₅O₁₂ (such as aerogel form)). During the charging process, when the lithium ion cell is absorbing power, lithium ions move through the electrolyte from the cathode to the anode and attach to the carbon. During the discharging process, when the lithium ion cell is giving out power, the lithium ions move back through the electrolyte from the carbon anode to the lithium cathode.

Pouch-type lithium ion batteries may be comprised of one of more lithium ion polymer cells, which may be connected to other pouch-type lithium ion batteries in series and/or in parallel.

Lithium ion cells in general, including lithium ion polymer batteries, are susceptible to “thermal runaway.” Pouch-type batteries may be more susceptible to “thermal runaway” than standard lithium ion battery cells, due to their less rigid construction. The term “thermal runaway” refers to a rapid uncontrolled increase in temperature. The electrolyte contained within the lithium ion cell may be highly flammable. In the event that the cell or module experiences a “thermal runaway” condition, the electrolyte or other materials contained within the cells may ignite causing an explosion and fire.

Pouch-type batteries may be most often found in small electronic devices, such as smart phones or tablet computers. Pouch-type batteries may be designed, with regard to electrical output and physical dimensions, for each particular desired use, and provide flexibility of design such that they may be incorporated into allotted space within small electronic devices.

Provided is a pouch-type electromechanical battery comprising at least one electrochemical battery cell encapsulated within a housing material comprising an inorganic platelet composition.

Further provided is a pouch-type electrochemical battery comprising at least one electrochemical battery cell encapsulated within a housing material comprising an inorganic platelet composition.

Further provided is a method for minimizing the propagation of thermal runaway within a pouch-type electrochemical battery comprising at least one electrochemical battery cell, the method comprising encapsulating the pouch-type electrochemical battery pack within a housing material comprising an inorganic platelet composition.

Further provided is a method for minimizing the propagation of thermal runaway within a pouch-type electrochemical battery comprising at least one electrochemical battery cell, the method comprising encapsulating the at least one electrochemical battery cell with housing comprising an inorganic platelet composition to form a pouch-type electrochemical battery pack.

Further provided is an electronic device comprising a pouch-type electrochemical battery comprising at least one electrochemical battery call encapsulated within a housing material comprising an inorganic platelet composition.

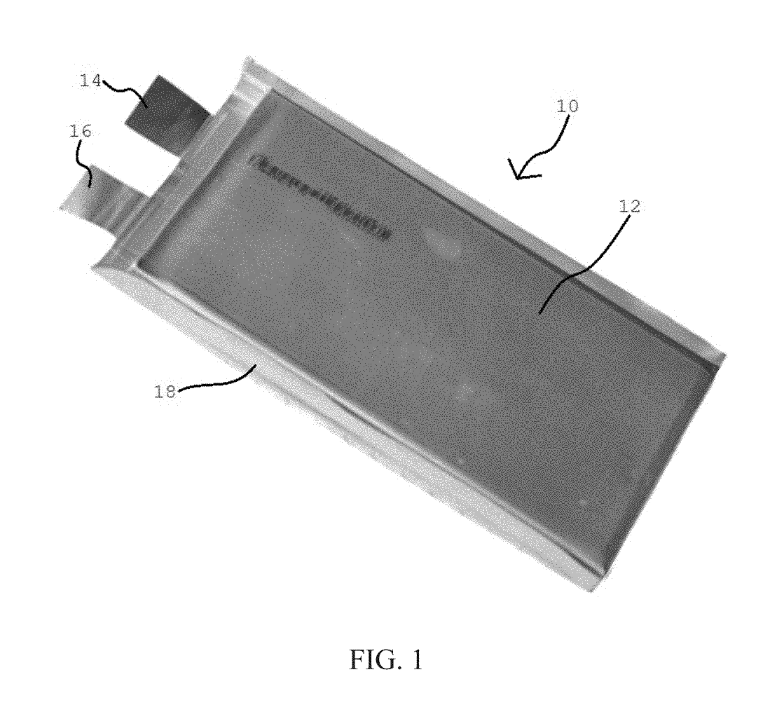

FIG. 1 depicts and illustrative pouch-type electrochemical battery.

Provided is means to mitigate the propagation of thermal runaway for a pouch-type electrochemical battery containing at least one electrochemical battery cell that mitigates the effects of one or more or the at least one battery cell undergoing a thermal runaway event, thereby preventing the propagation of the thermal runaway event to neighboring cells or batteries.

As shown in FIG. 1, an illustrative pouch-type electrochemical battery 10 comprises a housing material 12 which encapsulates at least one electrochemical battery cell (not shown), and electrical leads 14 and 16, which may be used to connect the battery 10 to a device utilizing electricity provided by the battery 10, or other pouch-type or other batteries. The battery 10 may optionally comprise a sealed portion 18, such as a heat-sealed portion, which allows for easy encapsulation of the at least one electrochemical battery cell.

According to certain embodiments, a pouch-type battery is provided that includes a housing material that is, or is based on an inorganic platelet composition. The housing material encapsulates at least one battery cell to prevent a thermal runaway event initiated in an individual cell or in a group of cells from propagating to other cells or nearby batteries.

As used throughout the present specification, the terms “battery”, “cell”, “battery cell” and “electrochemical cell” may be used interchangeably and may refer to any of a variety of different cell chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other battery type/configuration.

As used throughout the present specification, the term “battery pack ” as used herein refers to multiple individual battery cells contained within a suitable housing, the individual battery cells electrically interconnected to achieve the desired voltage and capacity for a particular application.

In certain embodiments, a pouch-type battery as described herein may include a single battery cell, multiple battery cells, or one or more battery packs within a single pouch-type battery.

The inorganic platelets of the inorganic platelet composition may be selected from vermiculite platelets, mica platelets, clay platelets, tale platelets and combination thereof.

According to certain embodiments, the inorganic platelets comprise vermiculite platelets. According to certain embodiments, the inorganic platelets comprise mica platelets. According to certain embodiments, the inorganic platelets comprise clay platelets. According to certain embodiments, the inorganic platelets comprise a blend a vermiculite and mica platelets.

The inorganic platelet composition may comprise coated platelets. Without limitation, and only by way of illustration, the inorganic platelets may be at least partially coated with a coating selected from, such as, for example, titanium dioxide, iron oxide, chromium oxide, tin oxide, silicon oxide, cobalt oxide, antimony oxide and combination thereof. According to certain other embodiments, the inorganic platelets may be entirely coated with a coating.

The inorganic platelets, such as vermiculite or mica platelets, that may be used to prepare the inorganic platelet composition may be exfoliated. By exfoliated or exfoliation, it is meant that the vermiculite or mica platelets are chemically or thermally expanded. According to other illustrative embodiments, the vermiculite or mica platelets may be exfoliated and defoliated. By defoliated or defoliation, it is meant that the exfoliated vermiculite or mica platelets are further processed in order to reduce the vermiculite or mica to substantially a desired platelet form.

Without limitation, and only by way of illustration, suitable mica material that may be used as the inorganic platelets in the inorganic platelet composition includes muscovite, phlogopite, biotite, lepidolite, glauconite, paragonite and zinnwaldite, and synthetic micas such as fluorophologopite. According to certain embodiments, the mica platelets are muscovite mica. According to other embodiments, the mica platelets are phlogopite mica.

Without limitation, and only by way of illustration, suitable platelet clay material that may be used as the inorganic platelets may include, without limitation, ball clay, bentonite, smectite, hectorite, kaolinite, montmorillonite, saponite, sepiolite, sauconite, or combinations thereof.

While any size inorganic platelet material may be used to prepare a housing material comprising an inorganic platelet composition, inorganic platelets with larger relative diameters and high diameter to thickness aspect ratios may be desirable due to their gas impermeability, as well as other properties such as flexibility and processibility. In certain illustrative embodiments, the inorganic platelets may have a diameter of from about 20 μm to about 300 μm. In further embodiments, the inorganic platelets may have a diameter of from about 40 μm to about 200 μm. In certain embodiments, the inorganic platelets may have an aspect ratio of from about 50:1 to about 2000:1. In certain embodiments, the inorganic platelets may have an aspect ratio of from about 50:1 to about 1000:1. In further embodiments, the inorganic platelets may have an aspect ratio of from about 200:1 to about 800:1.

The inorganic platelet composition may comprise inorganic platelets in an amount from about 20 to about 100 weight percent, based on the total weight of the inorganic platelet composition. The inorganic platelet composition may comprise inorganic platelets in an amount of least about 20 weight percent, based on the total weight of the inorganic platelet composition. The inorganic platelet composition may comprise inorganic platelets in an amount of least about 30 weight percent, based on the total weight of the inorganic platelet composition. The inorganic platelet composition may comprise inorganic platelets in an amount of least about 40 weight percent, based on the total weight of the inorganic platelet composition. The inorganic platelet composition may comprise inorganic platelets in an amount of least about 50 weight percent, based on the total weight of the inorganic platelet composition. The inorganic platelet composition may comprise inorganic platelets in an amount of least about 60 weight percent, based on the total weight of the inorganic platelet composition. The inorganic platelet composition may comprise inorganic platelets in an amount of least about 70 weight percent, based on the total weight of the inorganic platelet composition. The inorganic platelet composition may comprise inorganic platelets in an amount of least about 80 weight percent, based on the total weight of the inorganic platelet composition. The inorganic platelet composition may comprise inorganic platelets in an amount of least about 85 weight percent, based on the total weight of the inorganic platelet composition. The inorganic platelet composition may comprise inorganic platelets in an amount of least about 90 weight percent, based on the total weight of the inorganic platelet composition. The inorganic platelet composition may comprise inorganic platelets in an amount of least about 95 weight percent, based on the total weight of the inorganic platelet composition. The inorganic platelet composition may comprise inorganic platelets in an amount of least about 99 weight percent, based on the total weight of the inorganic platelet composition. The inorganic platelet layer of the inflation gas deflector composite may comprise platelets in art amount of 100 weight percent.

The inorganic platelet composition may comprise mica platelets in an amount of least about 20 weight percent, based on the total weight of the inorganic platelet composition. The inorganic platelet composition may comprise mica platelets in an amount of at least 30 weight percent, based on the total weight of the inorganic platelet composition. The inorganic platelet composition may comprise mica platelets in an amount of at least 40 weight percent, based on the total weight of the inorganic platelet composition. The inorganic platelet composition may comprise mica platelets in an amount of least about 50 weight percent, based on the total weight of the inorganic platelet composition. The inorganic platelet composition may comprise mica platelets in an amount of least about 60 weight percent, based on the total weight of the inorganic platelet composition. The inorganic platelet composition may comprise mica platelets in an amount of least about 70 weight percent, based on the total weight of the inorganic platelet composition. The inorganic platelet composition may comprise mica platelets in an amount of least about 80 weight percent, based on the total weight of the inorganic platelet composition. The inorganic platelet composition may comprise mica platelets in an amount of least about 85 weight percent, based on the total weight of the inorganic platelet composition. The inorganic platelet composition may comprise mica platelets in an amount of at least about 90 weight percent, based on the total weight of the inorganic platelet composition. The inorganic platelet composition may comprise mica platelets in an amount of least about 95 weight percent, based on the total weight of the inorganic platelet composition. The inorganic platelet composition may comprise mica platelets in an amount of least about 99 weight percent, based on the total weight of the inorganic platelet composition. The inorganic platelet composition may comprise mica platelets in an amount of least about 100 weight percent, based on the total weight of the inorganic platelet composition.

The inorganic platelet composition may comprise vermiculite platelets in an amount of least about 20 weight percent, based on the total weight of the inorganic platelet composition. The inorganic platelet composition may comprise vermiculite platelets in an amount of least about 30 weight percent, based on the total weight of the inorganic platelet composition. The inorganic platelet composition may comprise vermiculite platelets in an amount of least about 40 weight percent, based on the total weight of the inorganic platelet composition. The inorganic platelet composition may comprise vermiculite platelets in an amount of least about 50 weight percent, based on the total weight of the inorganic platelet composition. The inorganic platelet composition may comprise vermiculite platelets in an amount of least about 60 weight percent, based on the total weight of the inorganic platelet composition. The inorganic platelet composition may comprise vermiculite platelets in an amount of least about 70 weight percent, based on the total weight of the inorganic platelet composition. The inorganic platelet composition may comprise vermiculite platelets in an amount of least about 80 weight percent, based on the total weight of the inorganic platelet composition. The inorganic platelet composition may comprise vermiculite platelets in an amount of least about 85 weight percent, based on the total weight of the inorganic platelet composition. The inorganic platelet composition may comprise vermiculite platelets in an amount of least about 90 weight percent, based on the total weight of the inorganic platelet composition. The inorganic platelet composition may comprise vermiculite platelets in an amount of least about 95 weight percent, based on the total weight of the inorganic platelet composition. The inorganic platelet composition may comprise vermiculite platelets in an amount of at least about 99 weight percent, based on the total weight of the inorganic platelet composition. The inorganic platelet composition may comprise vermiculite platelets in an amount of at least about 100 weight percent, based on the total weight of the inorganic platelet composition.

The inorganic platelet composition may comprise a blend of mica and vermiculite platelets in an amount of least about 20 percent, based on the total weight of the inorganic platelet composition. The inorganic platelet composition may comprise a blend of mica and vermiculite platelets in an amount of least about 30 weight percent, based on the total weight of the inorganic platelet composition. The inorganic platelet composition may comprise a blend of mica and vermiculite platelets in an amount of least about 40 weight percent, based on the total weight of the inorganic platelet composition. The inorganic platelet composition may comprise a blend of mica and vermiculite platelets in an amount of least about 50 weight percent, based on the total weight of the inorganic platelet composition. The inorganic platelet composition may comprise a blend of mica and vermiculite platelets in an amount of least about 60 weight percent, based on the total weight of the inorganic platelet composition. The inorganic platelet composition may comprise a blend of mica and vermiculite platelets in an amount of least about 70 weight percent, based on the total weight of the inorganic platelet composition. The inorganic platelet composition may comprise a blend of mica and vermiculite platelets in an amount of least about 80 weight percent, based on the total weight of the inorganic platelet composition. The inorganic platelet composition may comprise a blend of mica and vermiculite platelets in an amount of least about 85 weight percent, based on the total weight of the inorganic platelet composition. The inorganic platelet composition may comprise a blend of mica and vermiculite platelets in an amount of least about 90 weight percent, based on the total weight of the inorganic platelet composition. The inorganic platelet composition may comprise a blend of mica and vermiculite platelets in an amount of least about 95 weight percent, based on the total weight of the inorganic platelet composition. The inorganic platelet composition may comprise a blend of mica and vermiculite platelets in an amount of least about 99 weight percent, based on the total weight of the inorganic platelet composition. The inorganic platelet composition may comprise a blend of mica and vermiculite platelets in an amount of least about 100 weight percent, based on the total weight of the inorganic platelet composition.

In certain embodiments, the inorganic platelet composition may comprise from about 20 to less than about 100 percent by weight of inorganic platelets and from greater than 0 to about 80 percent by weight of binder, based on the total weight of the inorganic platelet composition. In certain embodiments, the inorganic platelet composition may comprise from about 30 to less than about 100 percent by weight of inorganic platelets and from greater than 0 to about 70 percent by weight of binder, based on the total weight of the inorganic platelet composition. In certain embodiments, the inorganic platelet composition may comprise from about 40 to less than about 100 percent by weight of inorganic platelets and from greater than 0 to about 60 percent by weight of binder, based on the total weight of the inorganic platelet composition. In certain embodiments, the inorganic platelet composition may comprise from about 50 to less than about 100 percent by weight of inorganic platelets and from greater than 0 to about 50 percent by weight of binder, based on the total weight of the inorganic platelet composition. In certain embodiments, the inorganic platelet composition may comprise from about 60 to less than about 100 percent by weight of inorganic platelets and from greater than 0 to about 40 percent by weight of binder, based on the total weight of the inorganic platelet composition. In certain embodiments, the inorganic platelet composition may comprise from about 70 to less than about 100 percent by weight of inorganic platelets and from greater than 0 to about 30 percent by weight of the binder, based on the total weight of the inorganic platelet composition. In certain embodiments, the inorganic platelet composition may comprise from about 80 to less than about 100 percent by weight of inorganic platelets and from greater than 0 to about 20 percent by weight of binder, based on the total weight of the inorganic platelet composition.

In certain embodiments, the inorganic platelet composition may comprise from about 20 to less than about 100 percent by weight of inorganic platelets, from greater than 0 to about 40 percent by weight of binder, and from greater than 0 to about 50 percent by weight of a functional filler, based on the total weight of the inorganic platelet composition. In certain embodiments, the inorganic platelet composition may comprise from about 50 to less than about 100 percent by weight of inorganic platelets, from greater than 0 to about 30 percent by weight of binder, and from greater than 0 to about 20 percent by weight of a functional filler, based on the total weight of the inorganic platelet composition. In certain embodiments, the inorganic platelet composition may comprises from about 60 to less than about 100 percent by weight of said inorganic platelets, from greater than 0 to about 20 percent by weight of a binder, and from greater than 0 to about 20 percent by weight of a functional filler, based on the total weight of the inorganic platelet composition.

In certain embodiments, the inorganic platelet composition may comprise from about 20 to about less than 100 percent by weight of mica platelets, from greater than 0 to about 40 percent by weight of binder, and from greater than 0 to about 50 percent by weight of a functional filler, based on the total weight of the inorganic platelet composition. In certain embodiments, the inorganic platelet composition may comprise from about 50 to less than about 100 percent by weight of mica platelets, from greater than 0 to about 30 percent by weight of a binder, and from greater than 0 to about 20 percent by weight of a functional filler, based on the total weight of the inorganic platelet composition. In certain embodiments, the inorganic platelet composition may comprises from about 60 to less than about 100 percent by weight of said mica platelets, from greater than 0 to about 20 percent by weight of a binder, and from greater than 0 to about 20 percent by weight of a functional filler, based on the total weight of the inorganic platelet composition.

In certain embodiments, the inorganic platelet composition may comprise from about 20 to less than about 100 percent by weight of vermiculite platelets, from greater than 0 to about 40 percent by weight of binder, and from greater than 0 to about 50 percent by weight of a functional filler, based on the total weight of the inorganic platelet composition. In certain embodiments, the inorganic platelet composition may comprise from about 50 to less than about 100 percent by weight of vermiculite platelets, from greater than 0 to about 30 percent by weight of binder, and from greater than 0 to about 20 percent by weight of a functional filler, based on the total weight of the inorganic platelet composition. In certain embodiments, the inorganic platelet composition may comprises from about 60 to less than about 100 percent by weight of said vermiculite platelets, from greater than 0 to about 20 percent by weight of a binder, and from greater than 0 to about 20 percent by weight of a functional filler, based on the total weight of the inorganic platelet composition.

In certain embodiments, the inorganic platelet composition may comprise from about 20 to less than about 100 percent by weight of a blend of mica and vermiculite platelets, from greater than 0 to about 40 percent by weight of binder, and from greater than 0 to about 50 percent by weight of a functional filler, based on the total weight of the inorganic platelet composition. In certain embodiments, the inorganic platelet composition may comprise from about 50 to less than about 100 percent by weight of a blend mica and vermiculite platelets, front greater than 0 to about 30 percent by weight of binder, and from greater than 0 to about 20 percent by weight of a functional filler, based on the total weight of the inorganic platelet composition. In certain embodiments, the inorganic platelet composition may comprises from about 60 to less than about 100 percent by weight of said a blend of mica and vermiculite platelets, front greater than 0 to about 20 percent by weight of a binder, and from greater than 0 to about 20 percent by weight of a functional filler, based on the total weight of the inorganic platelet composition.

The inorganic platelet composition may include an organic and/or inorganic binder in addition to inorganic platelets. The binder may include a blend of more than one type of organic binder and one type of inorganic binder. The binder may include one type of organic binder and more than one type of inorganic binder. The binder may include a blend of more than one type of organic binder and more than one type of inorganic binder.

The organic binder may comprise a single type of organic binder or a blend of more than one type of organic binder. The organic binder(s) may be provided as a solid, a liquid, a solution, a dispersion, a latex, or similar form. Examples of suitable organic binders that may be included in the inorganic platelet layer include, but are not limited to, acrylic latex, (meth)acrylic latex, phenolic resins, copolymers of styrene and butadiene, vinylpyridine, acrylonitrile, copolymers of acrylonitrile and styrene, vinyl chloride, polyurethane, copolymers of vinyl acetate and ethylene, polyamides, silicones, organic silicones, organofunctional silanes, unsaturated polyesters, epoxy resins, polyvinyl esters (such as polyvinylacetate or polyvinylbutyrate latexes) and the like. According to certain embodiments, the organic binder included in the inorganic platelet composition comprises a silicone binder.

The inorganic binder may comprise a single type of inorganic binder or a blend of more than one type of inorganic binder. Without limitation, suitable inorganic binders that may be included in inorganic platelet composition include colloidal alumina, colloidal silica, colloidal zirconia, and mixtures thereof.

The inorganic platelet composition may include mica platelets and an inorganic binder. The inorganic binder may comprise a single type of inorganic binder or a blend of more than one type of inorganic binder. Without limitation, suitable inorganic binders that may be included in mica platelet composition may include colloidal alumina, colloidal silica, colloidal zirconia, and mixtures thereof.

The inorganic platelet composition may include vermiculite platelets and an inorganic binder. The inorganic binder may comprise a single type of inorganic binder or a blend of more than one type of inorganic binder. Without limitation, suitable inorganic binders that may be included in the vermiculite platelet composition include colloidal alumina, colloidal silica, colloidal zirconia, and mixtures thereof.

The inorganic platelet composition may include a blend of mica and vermiculite platelets and an inorganic binder. The inorganic binder may comprise a single type of inorganic binder or a blend of more than one type of inorganic binder. Without limitation, suitable inorganic binders that may be included in the inorganic platelet composition comprising a blend of mica and vermiculite platelets include colloidal alumina, colloidal silica, colloidal zirconia, and mixtures thereof.

The inorganic platelet composition may include mica platelets and at least one organic binder. The inorganic platelet composition may include vermiculite platelets and at least one organic binder. The inorganic platelet composition may include a blend of mica and vermiculite platelets and at least one organic binder.

For illustrative embodiments where the inorganic platelets are carried on a support layer, the inorganic platelets may be added to the support layer in an amount of about 25 gsm to about 500 gsm. According to certain embodiments, the inorganic platelets may be added to the support layer in an amount of about 30 gsm to about 40 gsm. According to other embodiments, the inorganic platelets may be added to the support layer in an amount of about 40 gsm to about 300 gsm.

The one or more support layer(s) of the housing material may comprise a polymer film, a paper, a non-woven fabric, a woven fabric or combinations thereof. The inorganic platelet composition (such as an inorganic platelet layer) may be adhered to the support layer through a suitable amount of adhesive positioned between the support layer and inorganic platelets.

The housing material may comprise a multiple layer composite comprising a support layer, an adhesive layer applied to a major surface of the support layer, and an inorganic platelet composition/layer applied to the adhesive layer. The inorganic platelet layer may be supplied as a fluid coating composition that is coated onto a major surface of the adhesive layer. Alternatively, the inorganic platelet layer may be first formed into a film, paper, or sheet, and then the sheet of inorganic platelets joined to the support layer with the adhesive layer being positioned between these two layers to bond the inorganic platelet sheet to the support layer. The multiple layer composite may further include a reinforcing layer. According to certain embodiments, the reinforcing layer may comprise an open weave reinforcing scrim. The reinforcing scrim may be placed adjacent the major surface of the support layer, may be embedded into the adhesive layer, may be embedded into the inorganic platelet layer, or any combination of one or more of these. The open weave reinforcing layer may be made from carbon fibers, glass fibers, high strength polymer fibers and combinations thereof.

In certain embodiments, pouch-type batteries have conventionally been made using housing materials made up of laminate material, such as a metal (e.g., aluminum) sheet or foil (having a thickness of, for example, about 25 μm), optionally including a polymer layer or coating (such as polymeric film as those described herein or others which have conventionally been used) at least partially covering at least one surface of the sheet or foil. The metal sheet or foil may function as a barrier against permeation of the laminate material, either into or out of the pouch-type batter, including moisture permeation. An optional outer polymer layer or coating may provide mechanical protection to the metal sheet or foil, and may comprise polyamide and/or polybutylene terephthalate, for example. An optional inner polymer layer or coating may provide chemical protection to the metal sheet or foil, and may comprise polypropylene, for example. The inorganic platelet composition described herein may be incorporated into such a housing material as a separate coating applied to at least one of: (i) the metal sheet or foil; (ii) the optional outer polymer layer or coating; or (iii) the optional inner polymer layer or coating. The inorganic platelet composition described herein may alternatively or additionally be incorporated into either or both of the optional polymer layers/coating, or may be incorporated into an adhesive that may be used to join either polymer layer/coating to the metal sheet/foil.

In certain embodiments, the metal sheet or foil may comprise aluminum foil. In certain embodiments, the metal sheet or foil may have a thickness of from about 5 μm to about 30 μm.

In certain embodiments, an outer layer or coating of polymeric material on the metal sheet or foil may comprise at least one of nylon, polyester, polyamide or polybutylene terephthalate. In certain embodiments, the outer layer or coating may have a thickness of about 10 μm to about 40 μm.

In certain embodiments, without limitation, an inner layer or coating of polymeric material on the metal sheet or foil may comprise a polyolefin polymer, such as polyethylene or polypropylene. In certain embodiments, the inner layer or coating may have a thickness of about 20 μm to about 40 μm.

In certain embodiments, the housing material may comprise an outer polymer layer or coating, a metal sheet or foil, and an inner polymer layer or coating. In certain embodiments, the housing material may comprise a laminate material comprising an outer polymer layer or coating, a metal sheet or foil, and an inner polymer layer or coating, and may include an adhesive material between one or more layers. In certain embodiments, more than one layer of a metal sheet or foil may be used, and a polymer layer and/or one or more adhesive layers may be interposed between adjacent metal sheet or foil layers. Utilizing a plurality of metal sheet or foil layers may reduce the chances of pinholes or other defects in the layer causing a failure of the housing material.

In certain embodiments, the housing material may comprise an inorganic platelet composition incorporated into and/or applied to any of the housing material layers/coating described in the previous paragraph. For example, in embodiments in which the housing material comprises a laminate material, the inorganic platelet composition may be incorporated into one or more of the polymer layers/coatings, and/or may be added as a distinct layer on the surface of or in between any of the other layers of the laminate material (as one or more distinct layers(s) of the inorganic platelet composition), and adhesive materials may optionally be used to adhere the layers of inorganic platelet composition to adjacent layers (or an adhesive or binder which is included in the inorganic platelet composition may serve this function).

In certain embodiments, the adhesive materials used to join adjacent layers of the housing material may comprise a polymer, such as a thermoset or thermoplastic polymer, or may comprise a solvent-cast adhesive or glue. In certain embodiments, the metal sheet or foil may be pre-treated, such as by oxidizing the outer surface of the metal sheet or foil, to increase adhesion to the adjacent layer.

In certain embodiments, the outer and/or inner polymer layer or coating may be subjected to a corona discharge treatment, which may eliminate the need for an adhesive material to join the polymer layer or coating to the metal sheet or foil.

In certain embodiments, the housing material may include moisture absorbing materials and/or so-called “acid getters”. These materials may comprise distinct materials, or may be incorporated into other materials of the housing material.

In certain embodiments, the pouch-type battery is encapsulated by the housing material by heat sealing the edges of the housing material at the peripheral edges of the pouch-type battery. Suitable heat sealing processes include, without limitation, thermal welding, ultrasonic welding, or using a heat seal adhesive. The housing material is positioned to surround the contents of the pouch-type battery such that the inner surfaces of the housing material joins itself. In certain embodiments, thermal welding the housing material includes heating a polymer layer/coating present on one or more of the inside surface(s) of the housing material such that it will bond or adhere to an adjacent inside surface of the housing material. In certain embodiments, the pouch-type battery may be subjected to a vacuum during the heat scaling process, to reduce or minimize the size of the pouch-type battery and at least partially remove extraneous gas from the battery.

According to certain illustrative embodiments, the one or more support layer(s) comprises a polymer film. The polymer film may be selected from polyester, polyimide, polyetherketone, polyetheretherketone, polyvinylfluoride, polyamide, polytetrafluoroethylene, polyaryl sulfone, polyester amide, polyester imide, polyethersulfone, polyphenylene sulfide, etheylene chlorotrifluoroethylene films and combinations thereof. According to certain embodiments, the polymer film comprises a polyetherketone film.

According to other illustrative embodiments, the one or more support layer(s) comprises a paper. The paper comprising the support layer may comprise an inorganic fiber paper, such as a paper containing inorganic fibers and binder. The inorganic fibers may be selected from high alumina polycrystalline fibers, mullite fibers, ceramic fibers, glass fibers, biosoluble fibers, quartz fibers, silica fibers and combinations thereof.

Any heat resistant inorganic fibers may be used to prepare the layer, sheet or paper so long as the inorganic fibers can withstand the forming process and can provide the minimum properties required by the application. Without limitation, and only by way of illustration, suitable inorganic fibers that may be used include high alumina polycrystalline wool fibers, refractory ceramic fibers such as alumina-silica fibers, alumina-magnesia-silica fibers, kaolin fibers, alkaline earth silicate fibers such as calcia-magnesia-silica fibers and magnesia-silica fibers, S-glass fibers, S2-glass fibers, E-glass fibers, quartz fibers, silica fibers and combinations of one or more of these types of inorganic fibers.

According to certain embodiments, the heat resistant inorganic fibers that are used to prepare the support layer for the inorganic platelets. Without limitation, and only by way of illustration, suitable refractory ceramic fibers include alumina fibers, alumina-silica fibers, alumina-zirconia-silica fibers, zirconia-silica fibers, zirconia fibers and similar refractory ceramic fibers. A suitable alumina-silica refractory ceramic fiber is commercially available from Unifrax I LLC (Tonawanda, N.Y., USA) under the registered trademark FIBERFRAX. The FIBERFRAX refractory ceramic fibers comprise the fiberization product of about 45 to about 75 weight percent alumina and about 25 to about 55 weight percent silica. The FIBERFRAX refractory ceramic fibers are able to withstand operating temperatures up to about 1540° C. and a melting point up to about 1870° C. The FIBERFRAX fibers are easily formed into high temperature resistant sheets and papers.

According to certain embodiments, the alumina-silica fiber may comprise from about 40 weight percent to about 60 weight percent Al₂O₃ and about 60 weight percent to about 40 weight percent SiO₂. According to other illustrative embodiments, the alumina-silica fiber may comprise about 50 weight percent Al₂O₃ and about 50 weight percent SiO₂.

The alumina-silica-magnesia glass fiber may comprise from about 64 weight percent to about 66 weight percent SiO2, from about 24 weight percent to about 25 weight percent Al₂O₃, and from about 9 weight percent to about 10 weight percent MgO.

In certain embodiments, the glass fibers may comprise the fiberization product of about 63 to about 67 weight percent SiO2, about 3 to 5 weight percent Al2O3, about 4 to about 7 weight percent CaO, about 2 to about 4 weight percent MgO, about 4 to about 7 weight percent B2O3, about 14 to 17 weight percent Na2O, greater than 0 to about 2 weight percent K2O, greater than 0 to about 1 weight percent ZnO, greater than 0 to about 1 weight percent Fe2O3, greater than 0 to about 1 weight percent BaO, and greater than 0 to about 1 weight percent F2.

Exemplary glass fiber compositions are set forth in the table below.

Glass Fiber Compositions (% by weight)

| | Glass A | Glass B | Glass C | Glass E |
|---|---|---|---|---|
| SiO₂ | 68.0-71.0 | 55.0-60.0 | 63.0-67.0 | 50.0-56.0 |
| Al₂O₃ | 2.5-4.0 | 4.0-7.0 | 3.0-5.0 | 13.0-16.0 |
| B₂O₃ | <0.09* | 8.0-11.0 | 4.0-7.0 | 5.8-10.0 |
| Na₂O | 10.5-12.0 | 9.5-13.5 | 14.0-17.0 | <0.50 |
| K₂O | 4.5-6.0 | 1.8-4.0 | <2.0 | <0.40 |
| CaO | 5.0-7.0 | 2.8-5.0 | 4.0-7.0 | 15.0-24.0 |
| MgO | 2.0-4.0 | <2.0 | 2.0-4.0 | <5.5 |
| Fe₂O₃ | <0.20 | <0.20 | <0.20 | <0.50 |
| ZnO | <2.0 | 2.0-5.0 | <0.10 | <0.02 |
| BaO | — | 3.0-6.0 | <0.10 | <0.03 |
| F₂ | — | <1.0 | <1.0 | <1.0 |
| TiO₂ | — | — | — | <1.0 |

*B₂O₃ contains 31.1% boron by weight. The maximum allowable boron content in A-Glass is 0.028%.

The E-glass fiber may comprise from about 52 weight percent to about 56 weight percent SiO₂, from about 16 weight percent to about 25 weight percent CaO, from about 12 weight percent to about 16 weight percent Al₂O₃, from about 5 weight percent to about 10 weight percent B₂O₃, up to about 5 weight percent MgO, up to about 2 weight percent of sodium oxide and potassium oxide and trace amounts of iron oxide and fluorides, with a typical composition of 55 weight percent SiO₂, 15 weight percent Al₂O₃, 7 weight percent B₂O₃, 3 weight percent MgO, 19 weight percent CaO and traces of the above mentioned materials.

Without limitation, suitable examples of alkaline earth silicate fibers that can be used to prepare the fiber paper support layer for the inorganic platelets include those fibers disclosed in U.S. Pat. Nos. 6,953,757, 6,030,910, 6,025,288, 5,874,375, 5,385,312, 5,332,699, 5,714,421, 7,259,118, 7,153,796, 6,861,381, 5,955,389, 5,928,075, 5,821,183, and 5,811,360, which are incorporated herein by reference.

According to certain embodiments, the alkaline earth silicate fibers may comprise the fiberization product of a mixture of oxides of magnesia and silica. These fibers are commonly referred to as magnesium-silicate fibers. The magnesium-silicate fibers generally comprise the fiberization product of about 60 to about 90 weight percent silica, from greater than 0 to about 35 weight percent magnesia and 5 weight percent or less impurities. According to certain embodiments, the magnesium-silicate fibers comprise the fiberization product of about 65 to about 86 weight percent silica, about 14 to about 35 weight percent magnesia and 5 weight percent or less impurities. According to other embodiments, the magnesium-silicate fibers comprise the fiberization product of about 70 to about 86 weight percent silica, about 14 to about 30 weight percent magnesia, and 5 weight percent or less impurities. A suitable magnesium-silicate fiber is commercially available from Unifrax I LLC (Niagara Falls, N.Y.) under the registered trademark ISOFRAX. Commercially available ISOFRAX fibers generally comprise the fiberization product of about 70 to about 80 weight percent silica, about 18 to about 27 weight percent magnesia and 4 weight percent or less impurities.

According to certain embodiments, the alkaline earth silicate fibers may comprise the fiberization product of a mixture of oxides of calcium, magnesium and silica. These fibers are commonly referred to as calcia-magnesia-silica fibers. According to certain embodiments, the calcia-magnesia-silica fibers comprise the fiberization product of about 45 to about 90 weight percent silica, from greater than 0 to about 45 weight percent calcia, from greater than 0 to about 35 weight percent magnesia, and 10 weight percent or less impurities. Useful calcia-magnesia-silica fibers are commercially available from Unifrax I LLC (Niagara Falls, N.Y.) under the registered trademark INSULFRAX. INSULFRAX fibers generally comprise the fiberization product of about 61 to 67 weight percent silica, from about 27 to about 33 weight percent calcia, and from about 2 to about 7 weight percent magnesia. Other suitable calcia-magnesia-silica fibers are commercially available from Thermal Ceramics (Augusta, Ga.) under the trade designations SUPERWOOL 607, SUPERWOOL 607 MAX and SUPERWOOL HT. SUPERWOOL 607 fibers comprise about 60 to about 70 weight percent silica, from about 25 to about 35 weight percent calcia, and from about 4 to about 7 weight percent magnesia, and trace amounts of alumina. SUPERWOOL 607 MAX fibers comprise about 60 to about 70 weight percent silica, from about 16 to about 22 weight percent calcia, and from about 12 to about 19 weight percent magnesia, and trace amounts of alumina. SUPERWOOL HT fiber comprise about 74 weight percent silica, about 24 weight percent calcia and trace amounts of magnesia, alumina and iron oxide.

Suitable silica fibers used in the production of the fiber paper support layer for inorganic platelets include those leached glass fibers available from BelChem Fiber Materials GmbH, Germany, under the trademark BELCOTEX, from Hitco Carbon Composites, Inc. of Gardena Calif., under the registered trademark REFRASIL, and from Polotsk-Steklovolokno, Republic of Belarus, under the designation PS-23(R).

The BELCOTEX fibers are standard type, staple fiver pre-yarns. These fibers have an average fineness of about 550 tex and are generally made from silica acid modified by alumina. The BELCOTEX fibers are amorphous and generally contain about 94.5 silica, about 4.5 percent alumina, less than 0.5 percent sodium oxide, and less than 0.5 percent of other components. These fivers have an average fiber diameter of about 9 microns and a melting point in the range of 1500° to 1550° C. These fibers are heat resistant to temperatures of up to 1100° C., and are typically shot free and binder free.

The REFRASIL fibers, like the BELCOTEX fibers, are amorphous leached glass fibers high in silica content for providing thermal initiation for applications in the 1000° to 1100° C. temperature range. These fibers are between about 6 and about 13 microns in diameter, and have a melting point of about 1700° C. The fibers, after leaching, typically have a silica content of about 95 percent by weight. Alumina may be present in an amount of about 4 percent by weight with other components being present in an amount of 1 percent or less.

The PS-23 (R) fibers from Polotsk-Steklovolokno are amorphous glass fibers high in silica content and are suitable for thermal insulation for applications requiring resistance to at least about 1000° C. These fibers have a fiber length in the range of about 5 to about 20 mm and a fiber diameter of about 9 microns. These fibers, like the REFRASIL fibers, have a melting point of about 1700° C.

The binder that may be included in the fiber paper may comprise an organic binder selected from acrylic latex, meth(acrylic) latex, phenolic resins, copolymers of styrene and butadiene, vinylpyridine, acrylonitrile, copolymers of acrylonitrile and styrene, vinyl chloride, polyurethane, copolymers of vinyl acetate and ethylene, polyamides, silicones, unsaturated polyesters, epoxy resins, polyvinyl esters and combinations thereof. According to other embodiments, the binder included in the fiber paper may comprise an inorganic binder. The inorganic binder may be selected from colloidal alumina, colloidal silica, colloidal zirconia and combinations thereof. The binder may include a blend of organic binder and inorganic binder. The binder may include a blend of more than one type of organic binder and one type of inorganic binder. The binder may include one type of organic binder and more than one type of inorganic binder. The binder may include a blend of more than one type of organic binder and more than one type of inorganic binder.

The one or more support layer(s) may comprise a woven fabric. The fibers of the woven fabric may comprise inorganic fibers, organic fibers, or a combination of inorganic and organic fibers. The inorganic fibers may be selected from carbon fibers and glass fibers. The organic fibers may be selected from polyolefin fibers, polyester fibers, polyamide fibers, aramid fibers and combinations thereof. According to other embodiments, the woven fabric is coated or impregnated with a coating composition.

The one or more support layers(s) may comprise a non-woven fabric. The fibers of the non-woven fabric may comprise inorganic fibers, organic fibers, or a combination of inorganic and organic fibers. The inorganic fibers may be selected from carbon fibers and glass fibers. The organic fibers may be selected from polyolefin fibers, polyester fibers, polyamide fibers, aramid fibers and combinations thereof.

In certain embodiments, the inorganic platelet composition/layer is directly or indirectly coated onto the support layer, applied to the support layer and permitted to impregnate or saturate into the thickness of the support layer, or impregnated into and coated onto the support layer. By indirectly coating, it is meant that the inorganic platelet layer may be coated onto a carrier layer, and the carrier layer engaged with the support layer with the inorganic layer disposed between the carrier layer and the support layer. The carrier layer then be removed leaving a multiple layer composite comprising the inorganic platelet layer on the support layer.

The inorganic platelet composition may be directly applied to a support layer, for example, without limitation, by roll or reverse roll coating, gravure or reverse gravure coating, transfer coating, spray coating, brush coating, dip coating, tape casting, doctor blading, slot-die coating, deposition coating, dipping, or by immersion. In certain embodiments, the inorganic platelet composition is applied to the support layer as a slurry of the ingredients in a solvent, such as water, and is allowed to dry. The inorganic platelet composition may be created as a single layer or coating on the support layer, thus utilizing a single pass, or may be created by utilizing multiple passes, layers or coatings. By utilizing multiple passes, the potential for formulation of defects in the inorganic platelet layer is reduced. If multiple passes are desired, the second and possible subsequent passes may be formed onto the first pass while the first pass is still substantially wet, i.e. prior to drying, such that the first and subsequent passes are from a single unitary layer upon drying.

The inorganic platelet composition may include a wide variety of functional fillers. For example, and without limitation, suitable functional fillers include heat resistant insulating fibers, endothermic materials, flame retardants, and combinations thereof.

The flame retardant material may be selected from any material that delays, inhibits, or slows the spread of fire by suppressing chemical reactions. According to certain embodiments, the flame retardant may comprise antimony compounds, magnesium hydroxide, aluminum hydroxides, aluminum trihydrate, aluminum oxide hydrate, boron compound such as borates, carbonates, bicarbonates, inorganic halides, sulfates, organic halogens, organic phosphorous compounds and combinations thereof. Suitable antimony compounds include, without limitation, antimony trioxide, antimony pentoxide and sodium animonate. Organic halogens include, for example, organobromines and organic chlorines. Suitable organobromines include, without limitation, decabromodiphenyl ether and decabromodiphenyl ethane. Suitable organobromines include polymeric brominated compounds such as brominated polystyrenes, brominated carbonate oligomers, brominated epoxy oligomers, tetrabromophthalic anhydride, tetrabromobisphenol A, and hexabromocyclododecane. Suitable organochlorides include, without limitation, derivatives of chlorenic acid and chlorinate paraffins. Suitable organophosphorus compounds include, without limitation, triphenyl phosphate, resorcinol bis(diphenylphosphate), bisphenol diphenyl phosphate, tricresyl phosphate, triarylphosphates, ammonium polyphosphate, trischloropropyl phosphate, red phosphorous, and phosphonates. Suitable phosphonates include, without limitation, dimethyl methylphosphonate, aluminum diethyl phosphonate, and metal phosphonates.

In certain embodiments, the inorganic platelet composition, an inorganic platelet composition composite or laminate material, and/or a composite or laminate material including the inorganic platelet composition, may include at least one of the following: (i) at least one material that alters the electrical properties of the composition, composite or laminate, such as an electrical insulation composition or material; (ii) a material which alters the heat transfer coefficient of the composition, composite or laminate, such as a material which dissipates heat; (iii) a material which provides moisture resistance to the composition, composite or laminate; (iv) and endothermic material; or (v) any other material which may conventionally be used in thermal/electrical insulation, such as for batteries.

In a first embodiment, provided is a pouch-type electrochemical battery comprising at least one electrochemical battery cell encapsulated within a housing material comprising an inorganic platelet composition.

The pouch-type electrochemical battery of the first embodiment may include that the at least one electrochemical battery cell comprises at least one lithium ion cell.

The pouch-type electrochemical battery of either of the first or subsequent embodiments may further include that the housing material comprises a composite comprising a support layer and an inorganic platelet composition layer. The support layer may comprise at least one of a polymer film, a paper, or a woven fabric. The polymer film may comprise at least one of polyester, polyimide, polyetherketone, polyetheretherketone, polyvinylfluoride, polyamide, polytetrafluoroethylene, polyaryl sulfone, polyester amide, polyester imide, polyethersulfone, polyphenylene sulfide, or ehtylene chlorotrifluoroethylene films. The support layer may comprise an inorganic fiber paper. The inorganic fiber paper may comprise inorganic fibers comprising at least one of the polycrystalline wool fibers, refractor ceramic fibers, kaolin fibers, mineral fibers, alkaline earth silicate fibers, calcia-alumina fibers, potassium-alumina-silica fibers, potassium-calcia-alumina fibers, S-glass fibers, S2-glass fibers, E-glass fibers, quartz fibers, or silica fibers. The inorganic fibers may comprise refractory ceramic fibers comprising the fiberization product of about 45 to about 75 weight percent alumina and about 25 to about 55 weight percent silica. The inorganic fibers may comprise alkaline and earth silicate fibers. The alkaline earth silicate fibers may comprise the fiberizatin product of about 60 to about 90 weight percent silica, from greater than 0 to about 35 weight percent magnesia and 5 weight percent or less impurities. The alkaline earth silicate fibers may comprise the fiberization product of about 45 to about 90 weight percent silica, from greater than 0 to about 45 weight percent calcia, from greater than 0 to about 35 weight percent magnesia, and 10 weight percent or less impurities. The alkaline earth silicate fibers may comprise the fiberization product of calcia and silica. The inorganic fibers comprise calcia-alumina fibers comprising from about 20 to about 80 weight percent calcia and from about 80 to about 20 weight percent alumina. The inorganic fibers may comprise silica fibers comprising 90 weight percent or greater silica. The inorganic fibers may comprise alumina fibers comprising 90 weight percent or greater alumina. The support layer may comprise a woven fabric.

The pouch-type electrochemical battery of any of the first or subsequent embodiments may include that the inorganic platelet composition comprises inorganic platelets comprising at least one of vermiculite, mica, clay, or talc platelets. The inorganic platelets may have a diameter of from about 20 μm to about 300 μm, such as from about 40 μm to about 200 μm. The inorganic platelets have an aspect ratio of from about 50:1 to about 2000:1, such as from about 50:1 to about 1000:1, or from about 200:1 to about 800:1. The inorganic platelet composition may comprise inorganic platelets in an amount from about 20 to about 100 weight percent, based on the total weight of the inorganic platelet composition. The inorganic platelet composition may comprise inorganic platelets in an amount of at least 20 weight percent, based on the total weight of the inorganic platelet composition. The inorganic platelet composition may comprise inorganic platelets in an amount of at least 30 weight percent, based on the total weight of the inorganic platelet composition. The inorganic platelet composition may comprise inorganic platelets in an amount of at least 40 weight percent, based on the total weight of the inorganic platelet composition. The inorganic platelet composition may comprise inorganic platelets in an amount of at least 50 weight percent, based on the total weight of the inorganic platelet composition. The inorganic platelet composition may comprise inorganic platelets in an amount of at least 60 weight percent, based on the total weight of the inorganic platelet composition. The inorganic platelet composition may comprise inorganic platelets in an amount of at least 70 weight percent, based on the total weight of the inorganic platelet composition. The inorganic platelet composition may comprise inorganic platelets in amount of at least 80 weight percent, based on the total weight of the inorganic platelet composition. The inorganic platelet composition may comprise inorganic platelets in an amount of at least 85 weight percent, based on the total weight of the inorganic platelet composition. The inorganic platelet composition may comprise inorganic platelets in an amount of at least 90 weight percent, based on the total weight of the inorganic platelet composition. The inorganic platelet composition may comprise inorganic platelets in an amount of at least 95 weight percent, based on the total weight of the inorganic platelet composition. The inorganic platelet composition may comprise inorganic platelets in an amount of at least 99 weight percent, based on the total weight of the inorganic platelet composition. The inorganic platelet composition may comprise inorganic platelets in an amount of 100 weight percent, based on the total weight of the inorganic platelet composition. The inorganic platelet composition may comprise vermiculite platelets in an amount of at least 20 weight percent, based on the total weight of the inorganic platelet composition. The inorganic platelet composition may comprise vermiculite platelets in an amount of at least 30 weight percent, based on the total weight of the inorganic platelet composition. The inorganic platelet composition may comprise vermiculite platelets in an amount of at least 40 weight percent, based on the total weight of the inorganic platelet composition. The inorganic platelet composition may comprise vermiculite platelets in an amount of at least 50 weight percent, based on the total weight of the inorganic platelet composition. The inorganic platelet composition may comprise vermiculite platelets in an amount of at least 60 weight percent, based on the total weight of the inorganic platelet composition. The inorganic platelet composition may comprise vermiculite platelets in an amount of at least 70 weight percent, based on the total weight of the inorganic platelet composition. The inorganic platelet composition may comprise vermiculite platelets in an amount of least 80 weight percent, based on the total weight of the inorganic platelet composition. The inorganic platelet composition may comprise vermiculite platelets in an amount of at least 85 weight percent, based on the total weight of the inorganic platelet composition. The inorganic platelet composition may comprise vermiculite platelets in an amount of at least 90 weight percent, based on the total weight of the inorganic platelet composition. The inorganic platelet composition may comprise vermiculite platelets in an amount of at least 95 weight percent, based on the total weight of the inorganic platelet composition. The inorganic platelet composition may comprise vermiculite platelets in an amount of at least 99 weight percent, based on the total weight of the inorganic platelet composition. The inorganic platelet composition may comprise vermiculite platelets in an amount or at least 100 weight percent, based on the total weight of the inorganic platelet composition. The inorganic platelet composition may comprise from about 20 to less than about 100 percent by weight of vermiculite platelets and from greater than 0 to about 80 percent by weight of binder, based on the total weight of the inorganic platelet composition. The inorganic platelet composition may comprise from about 30 to less than about 100 percent by weight of vermiculite platelets and from greater than 0 to about 70 percent by weight of binder, based on the total weight of the inorganic platelet composition. The inorganic platelet composition may comprise from about 40 to less than about 100 percent by weight of the vermiculite platelets and from greater than 0 to about 60 percent by weight of binder, based on total weight of the inorganic platelet composition. The inorganic platelet composition may comprise from about 50 to less than about 100 percent by weight of vermiculite platelets and from greater than 0 to about 50 percent by weight of binder, based on the total weight of the inorganic platelet composition. The inorganic platelet composition may comprise from about 60 to less than about 100 percent by weight of vermiculite platelets and from greater than 0 to about 40 percent by weight of binder, based on the total weight of the inorganic platelet composition. The inorganic platelet composition may comprise from about 70 to less than about 100 by weight of vermiculite platelets and from greater than 0 to about 30 percent by weight of binder, based on the total weight of the inorganic platelet composition. The inorganic platelet composition may comprise from about 80 to less than about 100 percent by weight of vermiculite platelets and from greater than 0 to about 20 percent by weight of binder, based on the total weight of the inorganic platelet composition. The inorganic platelet composition may comprise from about 20 to less than about 100 percent by weight of vermiculite platelets, from greater than 0 to about 40 percent by weight of binder, and from greater than 0 to about 50 percent by weight of a functional filler, based on the total weight of the inorganic platelet composition. The inorganic platelet composition may comprise from about 50 to less than about 100 percent by weight of vermiculite platelets, from greater than 0 to about 30 percent by weight of binder, and from greater than 0 to about 20 percent by weight of a functional filler, based on the total weight of the inorganic platelet composition. The inorganic platelet composition may comprise from about 60 to less than about 100 percent by weight of the vermiculite platelets, from greater than 0 to about 20 percent by weight of a binder, and from greater than 0 to about 20 percent by weight of a functional filler, based on the total weight of the inorganic platelet composition.

In a second embodiment provided is an electronic device comprising the pouch-type electrochemical battery of any one of the first or subsequent embodiments.

While the pouch-type battery has been described in connection with various embodiments, it is to be understood that other similar embodiments may be used or modifications and additions may be made to the described embodiments for performing the same function. Furthermore, the various illustrative embodiments may be combined to produce the desired results. The disclosure should not be limited to any single embodiment, but rather construed in breadth and scope in accordance with the recitation of the appended claims. It will be understood that the embodiments described herein are merely exemplary, and that one skilled in art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A pouch-type electrochemical battery comprising at least one electrochemical battery cell encapsulated within a housing material comprising an inorganic platelet composition.

2. The pouch-type electrochemical battery of claim 1, wherein the at least one electrochemical battery cell comprises at least one lithium ion cell.

3. The pouch-type electrochemical battery of claim 1, wherein the housing material comprises a composite comprising a support layer and an inorganic platelet composition layer.

4. The pouch-type electrochemical battery of claim 3, wherein the support layer comprises at least one of a polymer film, a paper, a non-woven fabric, or a woven fabric.

5. The pouch-type electrochemical battery of claim 3, wherein the support layer comprises a polymer film comprising at least one of the polyester, polyimide, polyetherketone, polyetheretherketone, polyvinylfluoride, polyamide, polytetrafluoroethylene, polyaryl sulfone, polyester amide, polyester imide, polyethersulfone, polyphenylene sulfide, or ethylene chlorotrifluoroethylene films.

6. The pouch-type electrochemical battery of claim 3, wherein the support layer comprises a fiber paper.

7. The pouch type electrochemical battery of claim 6, wherein the fiber paper comprises an inorganic fiber paper comprising inorganic fibers comprising at least one of polycrystalline wool fibers, refractory ceramic fibers, kaolin fibers, mineral fibers, alkaline earth silicate fibers, calcia-alumina fibers, potassium-alumina-silica fibers, potassium-calcia-alumina fibers, S-glass fibers, S2-glass fibers, E-glass fibers, quartz fibers, or silica fibers.

8. The pouch-type electrochemical battery of claim 3, wherein the support layer comprises a non-woven fabric.

9. The pouch-type electrochemical battery of claim 3, wherein the support layer comprises a woven fabric.

10. The pouch-type electrochemical battery of claim 1, wherein the inorganic platelet composition comprises inorganic platelets comprising at least one of the vermiculite, mica, clay, or talc platelets.

11. The pouch-type electrochemical battery of claim 10, wherein the inorganic platelets have a diameter of from about 20 μm to about 300 μm.

12. The pouch-type electrochemical battery of claim 10, wherein the inorganic platelets have as aspect ratio of from about 50:1 to about 2000:1.

13. The pouch-type electrochemical battery of claim 10, wherein the inorganic platelet composition comprises inorganic platelets in an amount from about 20 to about 100 weight percent, based on the total weight of the inorganic platelet composition.

14. The pouch-type electrochemical battery of claim 10, wherein the inorganic platelet composition comprises inorganic platelets in an amount of at least 20 weight percent, based on the total weight of the inorganic platelet composition.

15. The pouch-type electrochemical battery of claim 10, wherein the inorganic platelet composition comprises vermiculite platelets in an amount of at least 20 weight percent, based on the total weight of the inorganic platelet composition.

16. The pouch-type electrochemical battery of claim 10, wherein the inorganic platelet composition comprises form about 20 to less than 100 percent by weight of vermiculite platelets and from greater than 0 to about 80 percent by weight of a binder, based on the total weight of the inorganic platelet composition.

17. The pouch-type electrochemical battery of claim 10, wherein the inorganic platelet composition comprises from about 20 to less than about 100 percent by weight of vermiculite platelets, from greater than 0 to about 40 percent by weight of binder, and from greater than 0 to about 50 percent by weight of a functional filler, based on the total weight of the inorganic platelet composition.

18. The pouch-type electrochemical battery of claim 1, comprising a cathode, an anode, and a micro-porous electrolyte encapsulated within said housing.

19. The pouch-type electrochemical battery of claim 18, wherein each of said cathode, anode and electrolyte comprise prismatic rolls of thin sheets.

20. An electronic device comprising the pouch-type electrochemical battery of claim 1.
